(19) United States
(12) Patent Application Publication
(10) Pub. No.: US 2026/0014996 A1
(43) Pub. Date: Jan. 15, 2026

(54) DRIVING ASSISTANCE DEVICE AND DRIVING ASSISTANCE COMPUTER PROGRAM

(71) Applicant: TOYOTA JIDOSHA KABUSHIKI KAISHA, Toyota-shi Aichi-ken (JP)

(72) Inventor: Takuhiro Omi, Anjo-shi Aichi-ken (JP)

(73) Assignee: TOYOTA JIDOSHA KABUSHIKI KAISHA, Toyota-shi Aichi-ken (JP)

(21) Appl. No.: 19/260,834

(22) Filed: Jul. 7, 2025

(30) Foreign Application Priority Data
Jul. 9, 2024 (JP) 2024-110280

(51) Int. Cl. B60W 50/00; B60W 40/08

(52) U.S. Cl. CPC B60W 50/0098; B60W 40/08; B60W 2050/0083; B60W 2540/225; B60W 2555/60

(57) ABSTRACT

A driving assistance device includes: a processor configured to: detect a gaze direction of a driver of a vehicle, determine a confirmation status for a traffic light around the vehicle by the driver while the vehicle is stopped, based on a movement of the gaze direction, and change an application level of driving assistance to the driver based on the confirmation status.

### CROSS-REFERENCE TO RELATED APPLICATIONS

This application claims priority to Japanese Patent Application No. 2024-110280 filed Jul. 9, 2024, the entire contents of which are herein incorporated by reference.

### FIELD

The present disclosure relates to a driving assistance device and a driving assistance computer program that assists driving of a driver of a vehicle.

### BACKGROUND

A technique for detecting a state of a driver has been proposed (see Japanese Unexamined Patent Publication No. 2023-120874). The detection device disclosed in JP2023-120874 detects driving state information indicating a driving state related to at least one of a vehicle and a driver of the vehicle. Then, the detection device analyzes the detected driving state information to calculate hurry driving information indicating the degree of the tendency of hurry driving in the driver, and detects that the state of the driver is the hurry driving state on the basis of the calculated hurry driving information.

### SUMMARY

In the above-described technique, the tendency of hurry driving is determined based on the operation of the driver or the behavior of the vehicle when the vehicle is traveling. However, it is not desirable from the viewpoint of safety that the driver drives the vehicle in a state in which the driver is irritated. Therefore, it is desired to be able to determine the state of the driver before the driver's irritation appears in the behavior of the vehicle.

It is an object of the present disclosure to provide a driving assistance device capable of setting an appropriate driving assistance level with respect to state of a driver before the state of the driver appears in the behavior of the vehicle.

According to one embodiment, a driving assistance device is provided. The driving assistance device includes a processor configured to: detect a gaze direction of a driver of a vehicle, determine a confirmation status for a traffic light around the vehicle by the driver while the vehicle is stopped, based on a movement of the gaze direction, and change an application level of driving assistance to the driver based on the confirmation status.

In one embodiment, the processor determines, as the confirmation status, a frequency at which the gaze direction of the driver is toward a traffic light indicating whether or not traveling is possible in a road in a direction crossing the road in the traveling direction of the vehicle or a ratio of a period for which the gaze direction is toward the traffic light to a predetermined period, and when the frequency exceeds a predetermined frequency threshold value or the ratio exceeds a predetermined ratio threshold value, the processor changes the application level so that the application level of the driving assistance becomes higher.

In one embodiment, the processor determines, as the confirmation status, a duration for which the gaze direction of the driver continuously is toward a traffic light indicating whether or not traveling is possible in a road in a traveling direction of the vehicle, and when the duration exceeds a predetermined duration threshold, the processor changes the application level so that the application level of the driving assistance becomes higher.

In one embodiment, the processor is further configured to determine a state of the driver based on the confirmation status.

According to another embodiment, a non-transitory recording medium that stores a driving assistance computer program is provided. The driving assistance computer program causes a processor mounted on a vehicle to execute a process including: detecting a gaze direction of a driver of the vehicle; determining a confirmation status for a traffic light around the vehicle by the driver while the vehicle is stopped, based on a movement of the gaze direction; and changing an application level of driving assistance to the driver based on the confirmation status.

The driving assistance device according to the present disclosure has an effect that an appropriate driving assistance level can be set with respect to state of a driver before the state of the driver appears in the behavior of the vehicle.

### BRIEF DESCRIPTION OF DRAWINGS

FIG. 1 schematically illustrates the configuration of a vehicle on which a driving assistance device is mounted.

FIG. 2 is a functional block diagram of a processor of the ECU which is an example of the driving assistance device.

FIG. 3A is a diagram illustrating the state of a driver which confirms traffic lights around the vehicle.

FIG. 3B is a diagram illustrating the state of a driver which confirms traffic lights around the vehicle.

FIG. 4 is an operation flowchart of the driving assistance process.

FIG. 5 is a functional block diagram of a processor of the ECU according to the modified example.

### DESCRIPTION OF EMBODIMENTS

Hereinafter, a driving assistance device, a driving assistance method executed by the driving assistance device, and a driving assistance computer program will be described with reference to the drawings. The driving assistance device is configured to determine a confirmation status of a driver of a vehicle which confirms a traffic light around the vehicle while the vehicle is stopped, based on a movement of the gaze direction of the driver, and change an application level of the driving assistance to the driver based on the confirmation status.

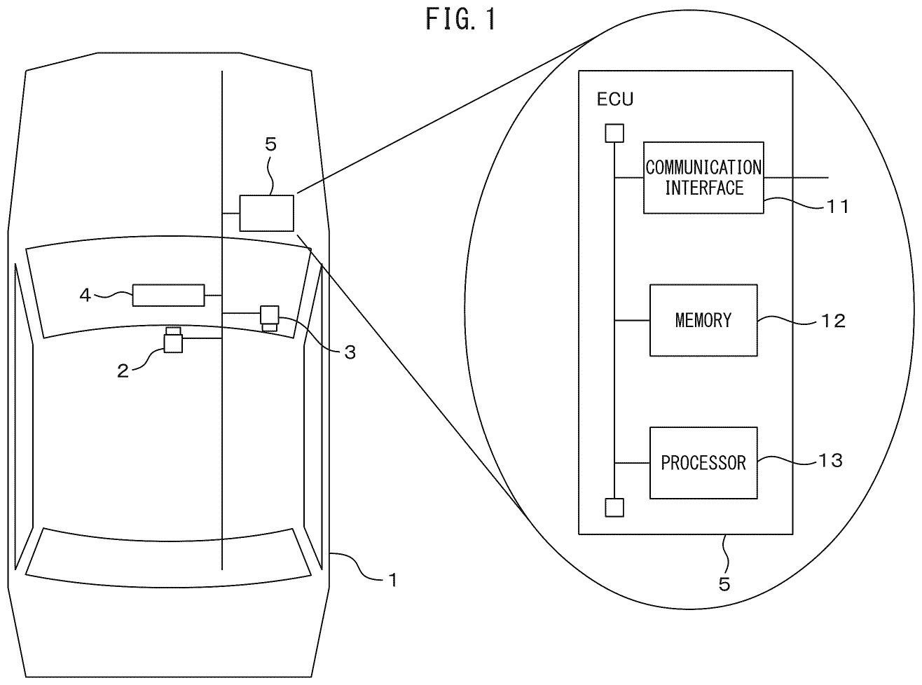

FIG. 1 schematically illustrates the configuration of a vehicle on which a driving assistance device is mounted. In the present embodiment, the vehicle 1 includes a camera 2, a driver monitor camera 3, a notification device 4, and an electronic control unit (ECU) 5 that is an example of the driving assistance device. The camera 2, the driver monitor camera 3, the notification device 4, and the ECU 5 are communicably connected to each other. Further, the vehicle 1 may include a range sensor (not shown) that measures a distance to an object around the vehicle 1, such as a LIDAR or a radar. Further, the vehicle 1 may include a positioning device (not shown) for measuring the position of the vehicle 1 by a satellite-based positioning device such as a GPS receiver.

The camera 2 is an example of an imaging unit, and is mounted on the vehicle 1 so as to be oriented to a predetermined region around the vehicle 1, such as a front region of the vehicle 1. The vehicle 1 may include a plurality of cameras having different shooting directions or different focal lengths. The camera 2 generates an image (hereinafter referred to as an “exterior image”) in which a predetermined region is represented by capturing an image of the predetermined region at each predetermined capturing period, and outputs the generated exterior image to the ECU 5.

The driver monitor camera 3 is an example of an interior imaging unit, and is mounted on or near an instrument panel and oriented to the driver so that the head of the driver seated on the driver seat of the vehicle 1 is included in the imaging target area. The driver monitor camera 3 may include a light source such as an infrared LED. Then, the driver monitor camera 3 generates an image (hereinafter referred to as a driver image) in which the driver is represented by capturing an image of the driver at every predetermined capturing period, and outputs the generated driver image to the ECU 5.

The notification device 4 is provided in the interior of the vehicle 1, and is a device that gives a predetermined notification to the driver by light, sound, vibration, character display, or image display. For this purpose, the notification device 4 includes, for example, at least one of a speaker, a light source, a vibrator, and a display device. When the notification device 4 receives a notification signal representing a predetermined notification from the ECU 5 to the driver, it executes the notification to the driver by the sound from the speaker, lighting up or blinking the light source, vibration of the vibrator, or displaying a notification message or an icon on the display.

The ECU 5 executes a driving assistance process. To this end, the ECU 5 includes a communication interface 11, a memory 12 and a processor 13. The communication interface 11, the memory 12, and the processor 13 may be configured as separate circuits or a single integrated circuit.

The communication interface 11 has interface circuitry for connecting the ECU 5 to other devices in the vehicle. The communication interface 11 passes the exterior image received from the camera 2 and the driver image received from the driver monitor camera 3 to the processor 13. The communication interface 11 outputs the notification signal received from the processor 13 to the notification device 4.

The memory 12 is an example of a storage unit, and includes, for example, a volatile semiconductor memory and a non-volatile semiconductor memory. The memory 12 stores various types of data used in the driving assistance process executed by the processor 13 or generated during the driving assistance process.

The processor 13 includes one or more central processing units (CPUs) and its peripheral circuitry. The processor 13 may further include other arithmetic circuits such as a logical operation unit, a numerical operation unit, or a graphics processing unit. Then, the processor 13 executes the driving assistance process.

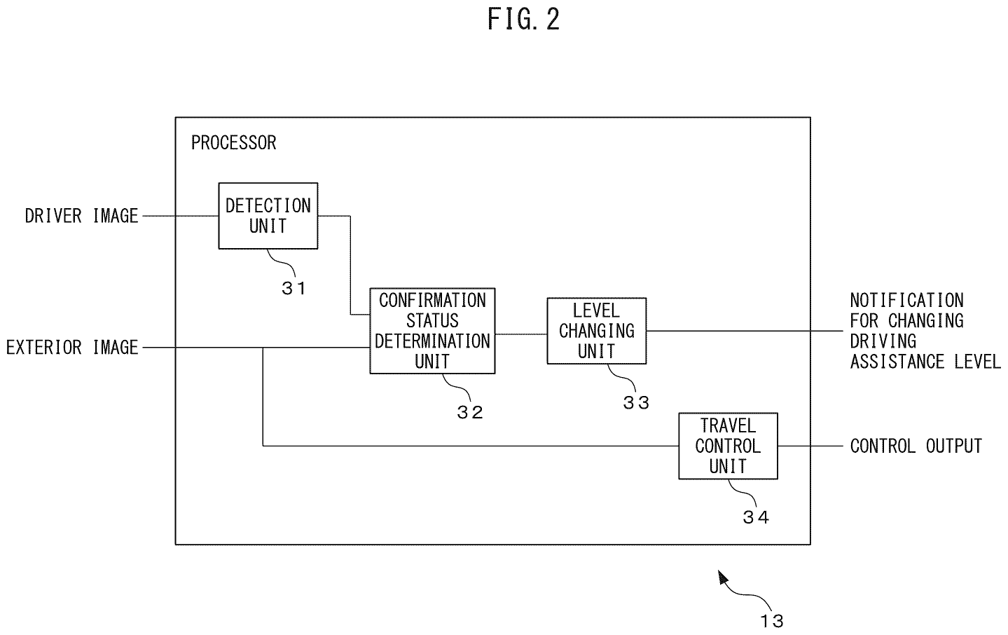

FIG. 2 is a functional block diagram of the processor 13 related to the driving assistance process. The processor 13 includes a detection unit 31, a confirmation status determination unit 32, a level changing unit 33, and a travel control unit 34. Each of these units included in the processor 13 is a functional module implemented by a computer program executed by the processor 13. Alternatively, each of these units included in the processor 13 may be a dedicated arithmetic circuit provided in the processor 13.

The detection unit 31 detects a gaze direction of the driver at each predetermined period. To this end, the detection unit 31 inputs the latest driver image to a classifier trained in advance so as to detect the eye, and detects a region in which the eye is represented on the driver image (hereinafter referred to as an eye region). Such a classifier is configured, for example, as a Deep Neural Network (DNN) with a convolutional neural network (CNN) type architecture, a support vector machine or an AdaBoost classifier. The detection unit 31 may detect the eye region from the driver image according to another method of detecting the eye region, such as template matching.

The detection unit 31 detects a corneal reflection image of the light source (hereinafter, referred to as a Purkinje image) and a centroid of the pupil (hereinafter, simply referred to as a pupil centroid) from the eye region for at least one of the left and right eyes of the driver represented in the driver image. At this time, the detection unit 31 detects the Purkinje image by template matching between the template of the Purkinje image and the eye region. Similarly, the detection unit 31 may detect the pupil by template matching between the template of the pupil and the eye region, and set the centroid of the region in which the detected pupil is represented as the pupil centroid. Then, the detection unit 31 calculates the direction and the distance from the Purkinje image to the pupil centroid, and detects the gaze direction of the driver by referring to a table representing the relationship between the direction and the distance and the gaze direction of the driver. Such a table may be stored in advance in the memory 12. Further, the detection unit 31 may detect the gaze direction of the driver from the driver image according to another method of detecting the gaze direction of the person represented in the image. The detection unit 31 notifies the confirmation status determination unit 32 of the detected gaze direction of the driver.

The confirmation status determination unit 32 determines the confirmation status for the traffic light around the vehicle 1 by the driver while the vehicle 1 is stopped, based on the movement of the gaze direction of the driver. When the vehicle speed of the vehicle 1 measured by a vehicle speed sensor (not shown) provided in the vehicle 1 is equal to or lower than the stop determination threshold (for example, 0.1 to 1 km/h), the confirmation status determination unit 32 determines that the vehicle 1 is stopped.

For example, while the vehicle 1 is stopped, the confirmation status determination unit 32 determines, as an index indicating the confirmation status for the traffic light, a frequency (hereinafter, referred to as a gaze frequency) at which the gaze direction of the driver is toward a traffic light indicating whether or not traveling is possible in a road in a direction crossing the road in the traveling direction of the vehicle 1 (hereinafter, referred to as a transverse traffic light). Alternatively, while the vehicle 1 is stopped, the confirmation status determination unit 32 may determine a ratio (hereinafter, referred to as a gaze time ratio) of the period for which the gaze direction of the driver is toward the transverse traffic light to a predetermined period as an index indicating the confirmation status for the traffic light. In order to determine whether or not the driver is looking at the traffic light, the confirmation status determination unit 32 detects the transverse traffic light from the exterior image of the vehicle. Then, the confirmation status determination unit 32 compares the detected azimuth to the transverse traffic light with the gaze direction of the driver detected from the driver image.

The confirmation status determination unit 32 inputs an exterior image to a classifier trained in advance so as to detect a traffic light from the exterior image, thereby detecting a region (hereinafter referred to as a traffic light region) in which the traffic light is represented in the exterior image and identifying a lighting state (blue, yellow, red, etc.) of the traffic light represented in the detected traffic light region. Such a classifier is configured, for example, as a CNN, a recursive neural network (RNN), or as a DNN with attention mechanisms. The confirmation status determination unit 32 determines, among the detected traffic light regions, a traffic light represented in a traffic light region detected at a position deviated from a partial region (hereinafter, referred to as a front direction region) on an exterior image corresponding to the front direction of the vehicle 1 as a transverse traffic light. The transverse traffic light may be a traffic light for a pedestrian or a traffic light for a vehicle. In addition, the transverse traffic light may be a traffic light having an auxiliary information indicator that indicates the time remaining until the transverse traffic light turns into a red signal. The position and size of the front direction region may be stored in the memory 12 in advance. Then, the confirmation status determination unit 32 determines the azimuth corresponding to the reference point (for example, the center or the centroid of the traffic light region) in the traffic light region in which the transverse traffic light is represented as the azimuth from the driver to the transverse traffic light.

When the angular difference between the specified azimuth from the driver to the transverse traffic light and the gaze direction of the driver detected by the detection unit 31 is included within a predetermined allowable range (for example, several degrees to 10 degrees), the confirmation status determination unit 32 determines that the gaze direction of the driver is toward the transverse traffic light. On the other hand, when the angular difference between the azimuth from the driver to the transverse traffic light and the gaze direction of the driver deviates from the predetermined allowable range, the confirmation status determination unit 32 determines that the gaze direction of the driver is not toward the transverse traffic light.

The confirmation status determination unit 32 repeats the above-described processing every predetermined period after the vehicle 1 stops. Then, the confirmation status determination unit 32 counts the number of times that the gaze direction of the driver is toward the transverse traffic light as the gaze frequency. Alternatively, once it is determined that the gaze direction of the driver is toward the transverse traffic light, the confirmation status determination unit 32 determines a duration until the next time when it is determined that the gaze direction is not toward the transverse traffic light. The confirmation status determination unit 32 calculates as the gaze time ratio, the ratio of the total of the duration to the length of the predetermined period. The predetermined period may be, for example, a preset period of several tens of seconds, or may be a period from when the vehicle 1 stops until when the transverse traffic light turns red. Note that the confirmation status determination unit 32 may determine whether or not the transverse traffic light has become red by referring to the identification result of the lighting state of the traffic light by the classifier for the traffic light region in which the transverse traffic light is represented.

In addition, while the vehicle 1 is stopped, the confirmation status determination unit 32 may determine a duration (hereinafter, referred to as a gaze duration) for which the gaze direction of the driver continuously is toward a traffic light (hereinafter, referred to as a traveling direction traffic light) indicating whether or not traveling is possible in the road in the traveling direction of the vehicle 1, as an index indicating the confirmation status for the traffic light. In this case, the confirmation status determination unit 32 determines the traffic light represented in the traffic light region included in the front direction region among the detected traffic light regions as the traveling direction traffic light. The traveling direction traffic light may be a traffic light for a pedestrian or a traffic light for a vehicle, similarly to the transverse traffic light. In addition, the traveling direction traffic light may be a traffic light having an auxiliary information indicator that indicates the time remaining until the traffic light turns into a blue signal. In addition, in a case where there are a plurality of traffic light regions included in the front direction region, the confirmation status determination unit 32 may determine, as the traveling direction traffic light, the traffic light represented in the largest traffic light region or the traffic light region located on the uppermost side or the leftmost side in the exterior image among the traffic light regions in the front direction region. Then, the confirmation status determination unit 32 determines the azimuth corresponding to the reference point in the traffic light region in which the traveling direction traffic light is represented as the azimuth from the driver to the traveling direction traffic light. Then, when the angular difference between the azimuth from the driver to the traveling direction traffic light and the gaze direction of the driver is included within a predetermined allowable range, the confirmation status determination unit 32 determines that the gaze direction of the driver is toward the traveling direction traffic light. On the other hand, when the angular difference between the azimuth from the driver to the traveling direction traffic light and the gaze direction of the driver deviates from the predetermined allowable range, the confirmation status determination unit 32 determines that the gaze direction of the driver is not toward the traveling direction traffic light.

The confirmation status determination unit 32 repeats the above-described processing every predetermined period after the vehicle 1 stops. Then, the confirmation status determination unit 32 may determine a duration from when it is once determined that the gaze direction of the driver is toward the traveling direction traffic light until the next time when it is determined that the gaze direction is not toward the traveling direction traffic light.

The confirmation status determination unit 32 may determine an azimuth from the driver to the transverse traffic light and an azimuth from the driver to the traveling direction traffic light based on the map information indicating the position and type of each traffic light, the stop position of the vehicle 1 determined by the positioning device, and the traveling direction of the vehicle 1 detected by an azimuth sensor (not shown) mounted on the vehicle 1.

According to the modification, the confirmation status determination unit 32 may determine whether the driver is looking at the transverse traffic light or the traveling direction traffic light based on only the driver image obtained during the predetermined period. In this case, the movement of the gaze direction when the driver gazes at a specific traffic light is trained in advance, and is stored in the memory 12 as the reference gaze behavior. The confirmation status determination unit 32 compares, for each sampling period shorter than the predetermined period, the detected movement of the gaze direction in the sampling period with the reference gaze behavior, and determines that the gaze direction of the driver is directed to a specific traffic light in the sampling period when the difference between the movement and the reference gaze behavior is included in a predetermined allowable range. Alternatively, the confirmation status determination unit 32 may determine whether or not the driver is looking at the transverse traffic light or the traveling direction traffic light by inputting the gaze direction to a gaze direction determination model each time the gaze direction of the driver is detected. The gaze direction determination model is configured as a DNN having a recursive structure such as an RNN.

The confirmation status determination unit 32 passes an index value indicating the confirmation status for the traffic light by the driver to the level changing unit 33.

The level changing unit 33 changes an application level of driving assistance to the driver in accordance with the confirmation status for the traffic light by the driver.

When the driver is irritated, the driver may gaze at a transverse traffic light (e.g., a pedestrian traffic light regarding the direction of crossing the road on which the vehicle 1 is traveling) so that the vehicle 1 can start moving as soon as the state of the traffic light for the traveling direction of the vehicle 1 changes to blue. It is then expected that the driver will attempt to check the timing at which the traffic light changes from blue to red as soon as possible. In such a case, the gaze frequency or the gaze time ratio for the transverse traffic light is high. Therefore, in a case where the gaze frequency or the gaze time ratio for the transverse traffic light is determined as the index value representing the confirmation status for the traffic light by the driver, the level changing unit 33 changes the level of the driving assistance to be applied so that the level of the driving assistance to be applied becomes higher when the gaze frequency exceeds a predetermined frequency threshold (for example, several tens of times) or the gaze time ratio exceeds a predetermined ratio threshold (for example, 0.4 to 0.7). Conversely, when the gaze frequency becomes less than the relaxation frequency threshold lower than the predetermined frequency threshold, the level changing unit 33 may change the level of the driving assistance to be applied so that the level of the driving assistance to be applied becomes lower. Alternatively, when the gaze time ratio is less than the relaxation ratio threshold value lower than the predetermined ratio threshold value, the level changing unit 33 may change the level of the driving assistance to be applied so that the level of the driving assistance to be applied becomes lower.

It is also expected that the driver will attempt to check the timing at which the traffic light changes from red to blue as soon as possible so that the vehicle 1 can start as soon as the state of the traffic light for the traveling direction of the vehicle 1 changes to blue when the driver is irritated. In such a case, the gaze duration with respect to the traveling direction traffic light becomes longer. Therefore, when the gaze duration for the traveling direction traffic light is determined as the index value indicating the confirmation status for the traffic light by the driver, the level changing unit 33 changes the level of the driving assistance to be applied so that the level of the driving assistance to be applied becomes higher when the gaze duration exceeds a predetermined duration threshold (for example, 10 seconds). Conversely, when the gaze duration is less than the relaxation duration threshold that is lower than the duration threshold, the level changing unit 33 may change the level of the driving assistance to be applied so that the level of the driving assistance to be applied becomes lower.

When a plurality of index values representing the confirmation status for the traffic light by the driver are determined, the level changing unit 33 changes the level of the driving assistance to be applied so that the level of the driving assistance to be applied becomes higher when any one of the plurality of index values exceeds the corresponding threshold value.

In a case where it is determined that the level of the driving assistance is to be higher and no driving assistance mode is applied at the present time, the level changing unit 33 sets the driving assistance mode in which the distance between the vehicle 1 and a preceding vehicle traveling ahead of the vehicle 1 is maintained at a predetermined distance or more as the driving assistance mode after the change. Alternatively, the level changing unit 33 may set the driving assistance mode in which the maximum value of the acceleration of the vehicle 1 is limited to be equal to or less than the upper limit acceleration as the driving assistance mode after the change. In addition, in a case where it is determined that the level of the driving assistance is to be higher and some driving assistance mode is applied at the present time, the level changing unit 33 may set the autonomous driving mode for automatically controlling the traveling of the vehicle 1 to the driving assistance mode after the change.

In this way, when the driver exhibits a behavior that is supposed to be irritated, it is possible to prevent the driver from driving recklessly by changing the level of the driving assistance to be applied to a higher one in advance.

In addition, in a case where it is determined that the level of the driving assistance is to be lowered, in a case where some driving assistance mode is currently applied, the level changing unit 33 may stop the application of the driving mode so that the driver manually controls the traveling of the vehicle 1.

When the level of the driving assistance being applied is changed, the level changing unit 33 notifies the driving assistance mode corresponding to the changed level to the traveling control unit 34. Further, when the level of the driving assistance being applied is changed, the level changing unit 33 may output a notification signal indicating that the level of the driving assistance has been changed and the driving assistance mode after the change to the notification device 4 via the communication interface 11. Thus, the driver is notified that the level of the driving assistance has been changed and the driving assistance mode after the change.

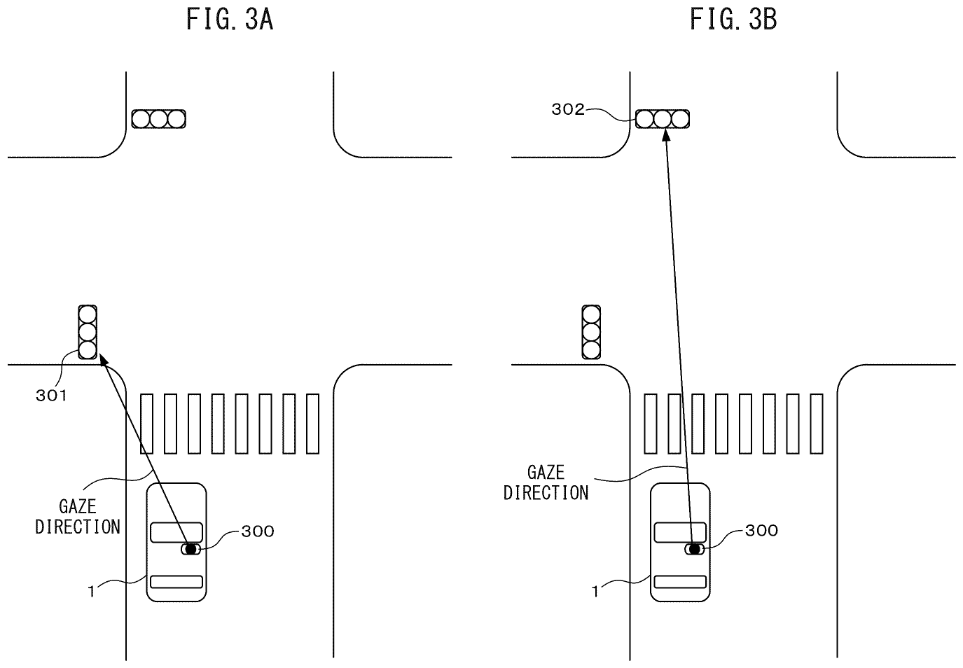

FIGS. 3A and 3B are diagrams illustrating the state of the driver which confirms traffic lights around the vehicle 1. In the embodiment shown in FIG. 3A, the driver 300 of the vehicle 1 is looking at the traffic light 301 for the road in a direction transverse to the traveling direction of the vehicle 1. As a result, when the gaze frequency for the traffic light 301 exceeds the predetermined frequency threshold value or the gaze time ratio exceeds the predetermined ratio threshold value, the level of the driving assistance is changed so that the level of the driving assistance to be applied becomes higher.

In the embodiment shown in FIG. 3B, the driver 300 of the vehicle 1 is looking at the traffic light 302 for the traveling direction of the vehicle 1. As a result, when the gaze duration for the traffic light 302 exceeds the duration threshold, the level of the driving assistance is changed so that the level of the driving assistance to be applied becomes higher.

The travel control unit 34 controls the travel of the vehicle 1 in accordance with the driving assistance mode of the level applied to the vehicle 1. For example, when the driving assistance mode to be applied is a driving assistance mode in which the distance between the preceding vehicle and the vehicle 1 is maintained at a predetermined distance or more, the travel control unit 34 detects the preceding vehicle from the exterior image. For this purpose, the travel control unit 34 detects another vehicle and lane division lines by inputting the exterior image to a classifier trained in advance so as to detect another vehicle traveling around the vehicle 1 and the lane division line from the exterior image. Such a classifier is configured as CNN or DNN with attention mechanisms. Then, the travel control unit 34 specifies, as the preceding vehicle, the detected other vehicle located in an arca sandwiched between the two lane division lines closest to the vehicle 1 on the exterior image. The travel control unit 34 estimates the distance from the vehicle 1 to the preceding vehicle on the basis of the parameters of the camera 2 such as the shooting direction and the installation position of the camera 2 and the position of the lower end of the object region representing the preceding vehicle, assuming that the position of the lower end of the object region indicates the position where the preceding vehicle is in contact with the road surface. In addition, in a case where a range sensor (not shown) is mounted on the vehicle 1, the travel control unit 34 may determine the distance of the azimuth corresponding to the object region in which the preceding vehicle is represented, which is measured by the range sensor, as the distance from the vehicle 1 to the preceding vehicle.

When the distance between the preceding vehicle and the vehicle 1 is less than the predetermined distance, the travel control unit 34 controls the powertrain or the brake of the vehicle 1 so that the distance between the preceding vehicle and the vehicle 1 increases. When the distance between the preceding vehicle and the vehicle 1 is equal to or greater than the predetermined distance, the travel control unit 34 controls the powertrain of the vehicle 1 so that the speed of the vehicle 1 approaches the target speed.

In addition, when the driving assistance mode in which the maximum value of the acceleration of the vehicle 1 is limited to the upper limit acceleration or less is applied, the travel control unit 34 controls the powertrain such that the acceleration corresponding to the accelerator operation by the driver is equal to or less than the upper limit acceleration.

Further, when the autonomous driving mode is applied, the travel control unit 34 detects lane division lines from the exterior image as described above. Then, the travel control unit 34 sets a planned trajectory along the center of the two lane division lines closest to the vehicle 1, and controls the steering device of the vehicle 1 so that the vehicle 1 travels along the set planned trajectory. Further, the travel control unit 34 controls the powertrain and the brake device so that the distance between the preceding vehicle and the vehicle 1 is maintained at a predetermined distance or more, as in the case where the driving assistance mode that maintains the distance between the preceding vehicle and the vehicle 1 at the predetermined distance or more is applied.

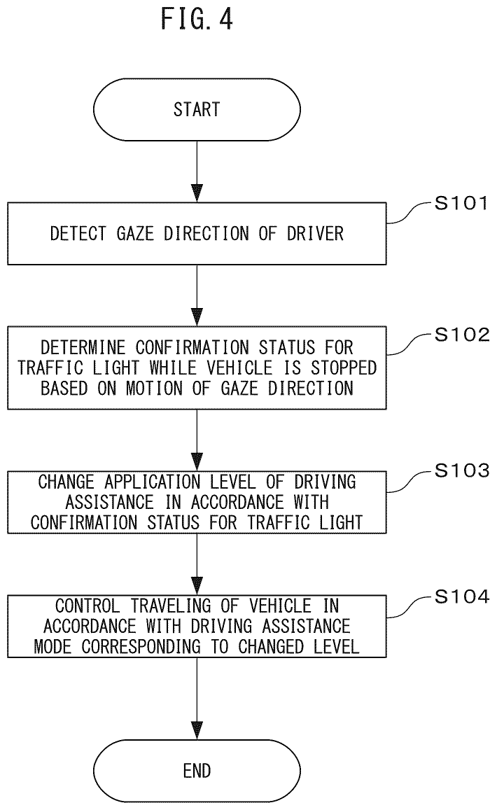

FIG. 4 is an operation flowchart of the driving assistance process executed by the processor 13.

The detecting unit 31 detects the gaze direction of the driver (step S101). The confirmation status determination unit 32 determines the confirmation status for the traffic light around the vehicle 1 by the driver while the vehicle 1 is stopped based on the movement of the gaze direction of the driver (step S102).

The level changing unit 33 changes the application level of the driving assistance to the driver in accordance with the confirmation status for the traffic light by the driver (step S103). The traveling control unit 34 controls the traveling of the vehicle 1 in accordance with the driving assistance mode corresponding to the changed level (step S104).

As described above, the driving assistance device changes the level of the driving assistance in accordance with the confirmation status for the traffic light by the driver while the vehicle is stopped. The confirmation status for the traffic light is one of the behavior of the driver representing the state of the driver. Therefore, the driving assistance device can set an appropriate driving assistance level for the state of the driver before the state of the driver appears in the behavior of the vehicle.

According to a modification, the processor 13 may be configured to determine the state of the driver according to the confirmation status for the traffic light by the driver while the vehicle 1 is stopped.

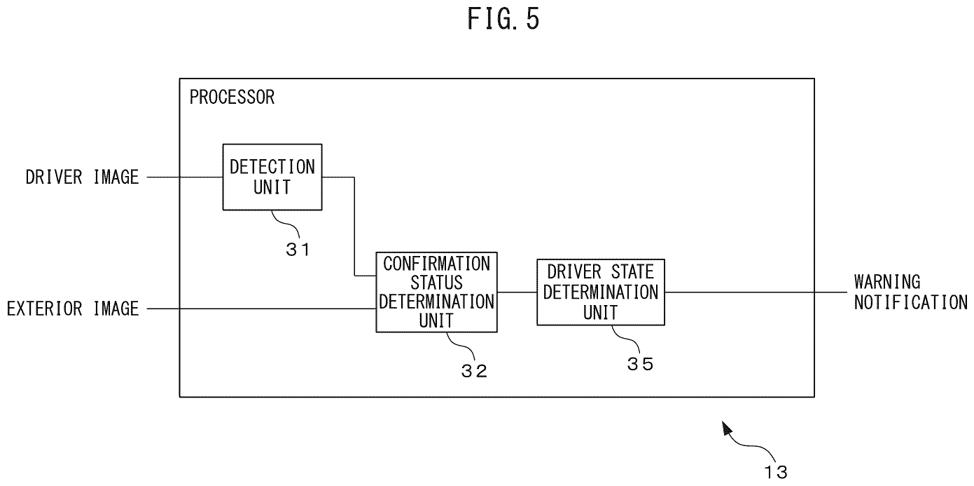

FIG. 5 is a functional block diagram of the processor 13 according to this modification. The processor 13 includes a detection unit 31, a confirmation status determination unit 32, and a driver state determination unit 35. Each of these units included in the processor 13 is, for example, a functional module implemented by a computer program executed by the processor 13. Alternatively, each of these units included in the processor 13 may be a dedicated arithmetic circuit provided in the processor 13. Compared to the above-described embodiment, this modification is different in that a driver state determination unit 35 is provided instead of the level changing unit 33 and the travel control unit 34. This difference will be described below.

The driver state determination unit 35 determines the state of the driver according to the confirmation status for the traffic light by the driver while the vehicle 1 is stopped. As described above, when the driver is irritated, the driver may watch the transverse traffic light so that the vehicle 1 can start as soon as the state of the traffic light for the traveling direction of the vehicle 1 changes to blue. Therefore, in a case where the gaze frequency or the gaze time ratio with respect to the transverse traffic light is determined as the index value representing the confirmation status for the traffic light by the driver, the driver state determination unit 35 determines that the state of the driver is a state where the driver is irritated when the gaze frequency exceeds a predetermined frequency threshold or the gaze time ratio exceeds a predetermined ratio threshold.

It is expected that the driver will attempt to check the timing at which the traffic light changes from red to blue as soon as possible so that the vehicle 1 can start as soon as the state of the traffic light for the traveling direction of the vehicle 1 changes to blue when the driver is irritated. Therefore, in a case where the gaze duration for the traveling direction traffic light is determined as the index value indicating the confirmation status for the traffic light by the driver, the driver state determination unit 35 may determine that the state of the driver is a state where the driver is irritated when the gaze duration exceeds a predetermined duration threshold.

When the driver state determination unit 35 determines that the driver is irritated, the driver state determination unit 35 notifies a warning that the driver is irritated via the notification device 4. For example, the driver state determination unit 35 causes a speaker included in the notification device 4 to output a sound such as “settle down”. In addition, the driver state determination unit 35 may execute a notification for calming the driver together with or instead of the warning notification. For example, the driver state determination unit 35 causes the speaker included in the notification device 4 to output music for relaxing the driver, or to output sound to be spoken to the driver so as to settle down.

According to this modification, since the driving assistance device determines the state of the driver based on the movement of the gaze direction of the driver while the vehicle is stopped, the driving assistance device can determine the state of the driver before the state of the driver appears in the behavior of the vehicle.

Further, in the above-described embodiment or modification example, the confirmation status determination unit 32 may also determine the gaze duration for the transverse traffic light or the gaze frequency or the gaze time ratio for the traveling direction traffic light while the vehicle 1 is stopped as an index indicating the confirmation status for the traffic light around the vehicle 1 by the driver. In this case also, the level changing unit 33 may change the level of the driving assistance so that the level of the driving assistance to be applied becomes higher when any one of the gaze frequency, the gaze time ratio, and the gaze duration exceeds a corresponding threshold value. Similarly, when any one of the gaze frequency, the gaze time ratio, and the gaze duration exceeds a corresponding threshold value, the driver state determination unit 35 may determine that the state of the driver is a state where the driver is irritated.

Further, in the above-described embodiment or modification example, the confirmation status determination unit 32 may also determine an index value indicating a state of the driver other than the movement of the gaze direction of the driver. For example, the confirmation status determination unit 32 may identify the facial expression of the driver by inputting the driver image to a classifier trained in advance so as to identify the facial expression of the driver. The classifier is then configured as a CNN or a DNN with attention mechanisms. Then, the classifier outputs an index value representing the facial expression of the driver. The level changing unit 33 may change the level of the driving assistance so that the level of the driving assistance to be applied becomes higher, when the index value related to the movement of the gaze direction satisfies the condition that it is determined that the driver is irritated and the index value representing the facial expression of the driver indicates that the facial expression is in an irritated state. According to this modification, not only the movement of the gaze direction of the driver while the vehicle 1 is stopped but also the facial expression of the driver is referred to, so that the driving assistance device can apply a driving assistance at a level more suitable for the state of the driver.

It should be noted that the embodiment shown in FIG. 2 and the modification shown in FIG. 5 may be combined. That is, the processor 13 may include the detection unit 31, the confirmation status determination unit 32, the level changing unit 33, the travel control unit 34, and the driver state determining unit 35. In this case, when the driver state determination unit 35 determines that the state of the driver is a state where the driver is irritated on the basis of the confirmation status for the traffic light by the driver while the vehicle 1 is stopped, the level changing unit 33 changes the level of the driving assistance so that the level of the driving assistance to be applied becomes higher. Then, the travel control unit 34 controls the travel of the vehicle 1 in accordance with the driving assistance mode of the applied level.

Further, the computer program for achieving the functions of the processor 13 of the ECU 5 according to the above-described embodiment or modification may be provided in a form recorded in a computer-readable portable recording medium such as a semiconductor memory, a magnetic recording medium, or an optical recording medium.

As described above, a skilled person can make various modifications according to the embodiment within the scope of the present disclosure.

What is claimed is:

1. A driving assistance device comprising:
a processor configured to:
detect a gaze direction of a driver of a vehicle,
determine a confirmation status for a traffic light around the vehicle by the driver while the vehicle is stopped, based on a movement of the gaze direction, and
change an application level of driving assistance to the driver based on the confirmation status.

2. The driving assistance device according to claim 1, wherein the processor determines, as the confirmation status, a frequency at which the gaze direction of the driver is toward a traffic light indicating whether or not traveling is possible in a road in a direction crossing the road in the traveling direction of the vehicle or a ratio of a period for which the gaze direction is toward the traffic light to a predetermined period, and
when the frequency exceeds a predetermined frequency threshold value or the ratio exceeds a predetermined ratio threshold value, the processor changes the application level so that the application level of the driving assistance becomes higher.

3. The driving assistance device according to claim 1, wherein the processor determines, as the confirmation status, a duration for which the gaze direction of the driver continuously is toward a traffic light indicating whether or not traveling is possible in a road in a traveling direction of the vehicle, and
when the duration exceeds a predetermined duration threshold, the processor changes the application level so that the application level of the driving assistance becomes higher.

4. The driving assistance device according to claim 1, wherein the processor is further configured to determine a state of the driver based on the confirmation status.

5. A non-transitory recording medium that stores a driving assistance computer program causing a processor mounted on a vehicle to execute a process comprising:
detecting a gaze direction of a driver of the vehicle;
determining a confirmation status for a traffic light around the vehicle by the driver while the vehicle is stopped, based on a movement of the gaze direction; and
changing an application level of driving assistance to the driver based on the confirmation status.
